(19) United States
(12) Patent Application Publication
(10) Pub. No.: US 2020/0402155 A1
(43) Pub. Date: Dec. 24, 2020

(54) SYSTEMS FOR PROVIDING REAL-TIME RESOURCE DISTRIBUTION TO A RESOURCE EVENT HAVING STANDARD DELAYED RESOURCE AVAILABILITY

(71) Applicant: BANK OF AMERICA CORPORATION, Charlotte, NC (US)

(72) Inventors: Manu Jacob Kurian, Dallas, TX (US); Jayachandra Varma, Irving, TX (US)

(21) Appl. No.: 16/447,525

(22) Filed: Jun. 20, 2019

(51) Int. Cl. G06Q 40/02; G06N 20/00; G06Q 20/10

(52) U.S. Cl. CPC G06Q 40/02; G06Q 20/102; G06N 20/00

(57) ABSTRACT

Real-time resource distribution/availability for a resource event that typically would otherwise incur a standard delay period in resource availability. The invention generates a resource depository and provides the resource depository with resources in an amount at least equal to the output of the resource event incurring the delay period. The resources in the resource depository are immediately available as an input another pending resource event. In addition, the present invention provides for implementing machine learning and/or artificial intelligence to determine which resources to use as the input for the resource event that incurs a delay period and/or the timing for conducting the resource event that incurs the delay period and/or the pending resource event.

### FIELD OF THE INVENTION

The present invention is generally directed distribution of resources via a distributed communication network and, more specifically, providing real-time resource distribution/availability for a resource event having standard delayed resource availability

### BACKGROUND

In many instances a resource event may incur a delay period from when the event occurs and when the output of the event (i.e., the resources) become available. In specific instances delay may last in terms of days. However, such resource events tend to be large volume resource events in which the output of the event is allocated as the input for another resource event. If the other resource event is time-sensitive (i.e., required to occur on or before the availability delay period lapses), the other resource event may be prevented from being conducted based on lack of an input.

Therefore, a need exists to develop systems, methods, computer program products and the like that provide real-time resource distribution/availability for a resource event that typically would otherwise incur a standard delay period in resource availability. In addition, a need exists to determine the inputs and/or the timing for the resource event so that optimal outputs can be achieved.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing systems, methods, computer program product and/or the like for real-time resource distribution/availability for a resource event that typically would otherwise incur a standard delay period in resource availability. In this regard the present invention determines a pending resource event is occurring a specified date and uses, as an input, the output from the resource event that incurs a delay period, beyond the specified date, in resource availability. In response to such a determination, a resource depository is generated and provided with resources in an amount at least equal to the output of the resource event that incurs the delay period. The resources in the resource depository are immediate available for use in conducting the pending resource event. In addition, the resource depository is linked to an existing resource depository, such that, any resources still existing in the generated resource depository after the delay period are automatically transferred to the existing resource depository.

In addition, the present invention provides for implementing machine learning and/or artificial intelligence to determine which resources to use as the input for the resource event that incurs a delay period and/or the timing for conducting the resource event that incurs the delay period and/or the pending resource event.

A system for providing real-time resource distribution to a resource event having conventional delayed resource accessibility defines first embodiments of the invention. The system includes a distributed communication network and a computing platform disposed in a distributed communication network. The computing platform includes a memory and at least one processor in communication with the memory. The memory stores instructions that are executable by the processor and configured to determine a pending resource event occurring on a specified date. The pending resource event uses an output of a second resource event. The output of the second resource event is not accessible until a time period after the specified date, specifically one or more days after the specified date. In response to conducting the second resource event on or before the specified date, the instructions are configured to generate a resource depository and provide the resource depository with first resources in an amount equal to the output of the second resource event. The first resources in the resource depository are available for immediate use as the input for conducting the pending resource event on the specified date. Additionally, the instructions are configured to link the resource depository to an existing second resource depository, such that, upon expiration of the time period after the specified date, first resources remaining in the resource depository are automatically transferred to the existing second resource depository.

In specific embodiments of the system, the instructions are further configured to implement/execute at least one of (i) one or more machine-learning models, or (ii) one or more artificial intelligence models to determine one or more inputs for the second resource event. In such embodiments of the system, the instructions may be further configured to receive real-time data feeds indicating at least one of (i) input performance, (ii) input trends, and (iii) input ratings, and determine the one or more inputs for the second resource event based at least on one or more of (i) the input performance, (ii) the input trends, and (iii) the input ratings. In still other related embodiments of the system, the instructions are further configured to determine one or more inputs one or more for the second resource event based at least on a predetermined input profile.

In other specific embodiments of the system, the instructions are configured to implement at least one of (i) one or more machine-learning models, or (ii) one or more artificial intelligence models to determine a timing for conducting the second resource event. In such embodiments of the system, the instructions may be further configured to receive real-time data feeds indicating at least one of (i) input performance, (ii) input trends, and (iii) input ratings, and determine the timing for the second resource event based at least on one or more of (i) the input performance, (ii) the input trends, and (iii) the input ratings.

In still further specific embodiments of the system the instructions are configured to implement at least one of (i) one or more machine-learning models, or (ii) one or more artificial intelligence models to determine the specified date for conducting the pending resource event.

Moreover, in additional embodiments of the system, the instructions are further configured to, in response to expiration of the time period after the specified date or using all of the first resources in the resource depository, delete the resource depository.

A computer-implemented method for providing real-time resource distribution to a resource event having conventional delayed resource accessibility defines second embodiments of the invention. The method is executed by one or more computing processing device. The method includes determining a pending resource event occurring on a specified date. The pending resource event uses an output of a second resource event. The output of the second resource event is not accessible until a time period after the specified date. The method further includes, in response to conducting the second resource event on or before the specified date, generating a resource depository and providing the resource depository with first resources in an amount equal to the output of the second resource event. The first resources in the resource depository are available for immediate use as the input for conducting the pending resource event on the specified date. The method further includes linking the resource depository to an existing second resource depository, wherein upon expiration of the time period after the specified date, first resources remaining in the resource depository are automatically transferred to the existing second resource depository.

In specific embodiments the method further includes executing at least one of (i) one or more machine-learning models, or (ii) one or more artificial intelligence models to determine one or more inputs for the second resource event. In further embodiments the method includes executing at least one of (i) one or more machine-learning models, or (ii) one or more artificial intelligence models to determine a timing for conducting the second resource event. While in further specific embodiments the method includes executing at least one of (i) one or more machine-learning models, or (ii) one or more artificial intelligence models to determine the specified date for conducting the pending resource event.

Moreover, in additional specific embodiments of the method includes, in response to expiration of the time period after the specified date or using all of the first resources in the resource depository, deleting the resource depository.

A computer program product including a non-transitory computer-readable medium defines third embodiments of the invention. The instructions include a first set of codes for causing a computer to determine a pending resource event on a specified date. The pending resource event uses an output of a second resource event. The output of the second resource event is not accessible until a time period after the specified date. The instructions additionally include a second set of codes for causing a computer to, in response to conducting the second resource event on or before the specified date, (i) generate a resource depository, (ii) provide the resource depository with first resources in an amount equal to the output of the second resource event, wherein the first resources in the resource depository are available for immediate use as the input for conducting the pending resource event on the specified date, and (iii) link the resource depository to an existing second resource depository, wherein upon expiration of the time period after the specified date, first resources remaining in the resource depository are automatically transferred to the existing second resource depository.

In specific embodiments of the computer program product, the instructions further include a third set of codes for causing a computer to execute at least one of (i) one or more machine-learning models, or (ii) one or more artificial intelligence models to determine one or more inputs for the second resource event. In other specific embodiments of the computer program product, the instructions further include a third set of codes for causing a computer to execute at least one of (i) one or more machine-learning models, or (ii) one or more artificial intelligence models to determine a timing for conducting the second resource event. In still further specific embodiments of the computer program product the instructions further include a third set of codes for causing a computer to execute at least one of (i) one or more machine-learning models, or (ii) one or more artificial intelligence models to determine the specified date for conducting the pending resource event.

Thus, according to embodiments of the invention, which will be discussed in greater detail below, the present invention provides for real-time resource distribution/availability for a resource event that typically would otherwise incur a standard delay period in resource availability. The invention generates a resource depository and provides the resource depository with resources in an amount at least equal to the output of the resource event incurring the delay period. The resources in the resource depository are immediately available as an input another resource event. In addition, the present invention provides for implementing machine learning and/or artificial intelligence to determine which resources to use as the input for the resource event that incurs a delay period and/or the timing for conducting the resource event that incurs the delay period and/or the pending resource event.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the disclosure in general terms, reference will now be made to the accompanying drawings, wherein:

FIG. 1 is a schematic diagram of a system for providing real-time resource distribution to a resource event having conventional delayed resource accessibility, in accordance with some embodiments of the present disclosure;

FIG. 2 is a combination timeline and block diagram of a system for providing real-time resource distribution to a resource event having conventional delayed resource accessibility, in accordance with some embodiments of the present disclosure;

FIG. 3 is a block diagram of an a computing platform configured providing real-time resource distribution to a resource event having conventional delayed resource accessibility, in accordance with some embodiments of the present disclosure; and

FIG. 4 is a flow diagram of a method for providing real-time resource distribution to a resource event having conventional delayed resource accessibility, in accordance with some embodiments of the present disclosure.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As will be appreciated by one of skill in the art in view of this disclosure, the present invention may be embodied as a system, a method, a computer program product or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer-readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as JAVA, PERL, SMALLTALK, C++, PYTHON or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or systems. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions, which implement the function/act specified in the flowchart and/or block diagram block or blocks.

The computer program instructions may also be loaded onto a computer or other programmable data processing apparatus to cause a series of operational events to be performed on the computer or other programmable apparatus to produce a computer implemented process such that the instructions, which execute on the computer or other programmable apparatus, provide events for implementing the functions/acts specified in the flowchart and/or block diagram block or blocks. Alternatively, computer program implemented events or acts may be combined with operator or human implemented events or acts in order to carry out an embodiment of the invention.

As the phrase is used herein, a processor may be “configured to” perform or “configured for” performing a certain function in a variety of ways, including, for example, by having one or more general-purpose circuits perform the function by executing particular computer-executable program code embodied in computer-readable medium, and/or by having one or more application-specific circuits perform the function.

Thus, according to embodiments of the invention, which will be described in more detail below, systems, methods and computer program products are disclosed for real-time resource distribution/availability for a resource event that typically would otherwise incur a standard delay period in resource availability. For example, real-time distribution of the proceeds of a security investment/stock sale, real-estate sale or the like. Specifically, the invention provides for making the resources outputted from such a resource event available for another pending resource event that is occurring on a specified date. For example, making the proceeds of the security investment//stock sale or real estate sale available immediately for another, typically large amount, financial transaction that is required to occur prior to the lapse of the standard delay period.

In response to such a determination, a resource depository is generated and provided with resources in an amount at least equal to the output of the resource event that incurs the delay period. In specific embodiments, the resource depository is a financial account, such as a stock or real estate divestiture account that is funded with sufficient resources/funds in an amount at least equal to the amount required of the other financial transactions. The resources the resources in the resource depository are immediate available for use in conducting the other pending resource event. In specific embodiments of the invention, the funds in the stock or real estate divestiture account are immediately available to conduct the financial transaction that precipitates the need to generate the account. In addition, the resource depository is linked to an existing resource depository, such that, any resources still existing in the generated resource depository after the delay period are automatically transferred to the existing resource depository. For example, in specific embodiments of the invention, the stock or real estate divestiture account is linked to a customer's savings and or checking accounts, such that, funds still existing in the stock or real estate divestiture account are automatically transferred to the savings/checking upon lapse of the delay period.

In addition, the present invention provides for implementing machine learning and/or artificial intelligence to determine which resources to use as the input for the resource event that incurs a delay period and/or the timing for conducting the resource event that incurs the delay period and/or the pending resource event. For example, in specific embodiments of the invention, machine learning and/or artificial intelligence are implemented to determine which stocks/real estate to sell or which combination of stocks/real-estate to sell and the timing for such a sale. In other embodiments of the invention, machine learning and/or artificial intelligence are implemented to determine the timing for conducting the pending financial transaction.

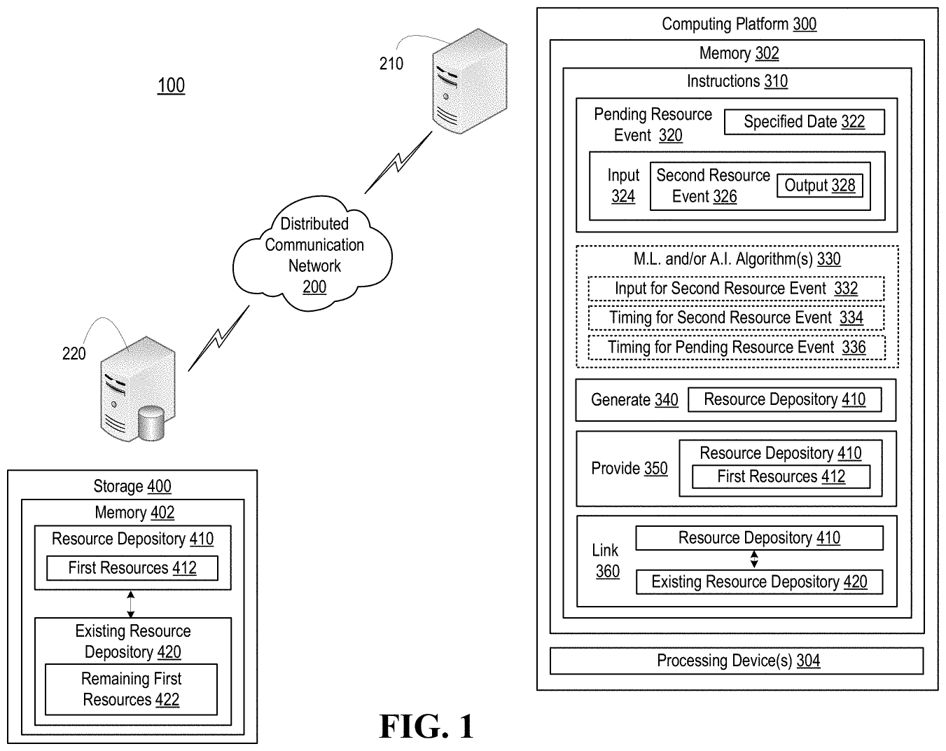

Turning now to the figures, FIG. 1 a schematic diagram is provided of a system 100 for providing real-time resource distribution to a resource event having conventional delayed resource accessibility, in accordance with embodiments of the present invention. The system includes a distributed communication network 200, which may include the Internet and/or one or more intranets or the like, which provide for networked communication between apparatus in the network 200, including, but not limited to, server apparatus 210 and storage apparatus 220.

Server apparatus 210, which may include one or more computing devices/server devices provides for computing platform 300, which includes or is in communication with memory 302 and one or more processing devices 304 in communication with the memory 302. The memory 302 stores instructions 310 that are executable by the one or more processors 304.

The instructions are configured to determine a pending resource event 320 occurring on a specified date 322. The pending resource event 320 is configured to use, as an input 324, the output 328 of a second resource event 326. The output 328 of the second resource event 326 is not accessible until a time period (e.g., one or more days) after the specified date 322. In specific embodiments of the system 100, the pending resource event 320 is a pending financial transaction, typically a financial transaction that requires a large volume of funds. In such embodiments of the system 100, the pending financial transaction may be configured to use the funds resulting from a distribution of a security investment (e.g., stocks, mutual fund, commodities, or the like), real property or the like in which the distribution is not typically available to the seller until after a delay period (e.g., three days or the like).

In specific optional embodiments of the system 100, the instructions 310 are further configured to implement one or more Machine Learning (ML) algorithms/models and/or one or more Artificial Intelligence (AI) algorithms/models 330 to determine (i) an input for the second resource event 332, (ii) timing for the second resource event 334 and/or (iii) timing for the pending resource event 336. In specific embodiments of the system 100, in which the pending resource event 320 is a financial transaction and the second resource event 326 is a security investment divestiture, the ML and/or AI algorithms/models 330 are implemented to determine which security investments or real properties to divest (e.g., which stock or combination of stocks to divest and/or which real property or properties to divest). In such embodiments of the system 100, the ML and/or AI algorithms models 330 may be further configured to determine the timing (e.g., date and, in some embodiments hour/minute) for the divesture of the security investment and/or real property and/or the timing (e.g., specific date) for the occurrence of the pending financial transaction.

The instructions 310 are further configured, in response conducting the second resource event 326 on or before the specified date 322, generate 340 a resource depository 410 within the memory 402 of storage unit 400 of storage apparatus 220 and provide 350 the resource depository 410 with first resources 412 in an volume/amount equal the output 328 of the second resource event and/or equal to or greater than the input 324 of the pending resource event 320. The first resources 412 provided to the resource depository 410 are available for immediate use an input 324 for conducting the pending resource event 320 on the specified date 322. In specific embodiments of the system 100, in which the pending resource event 320 is a financial transaction and the second resource event 326 is a security investment divestiture, in response to conducting the security investment/real property divesture on or before the specified date of the financial transaction, a stock or real estate divestiture account is created. Funds equal to the amount of the stock or real estate divestiture or an amount sufficient to fund the financial transaction are placed in the account and made immediately available for conducting the financial transaction. The funds in the stock or real estate divestiture account are provided by a financial institution or another entity that has control over the funds coming from stock or real estate divestiture and act as a virtual short-term loan, since the actual funds from the stock or real estate divestiture are not available to the seller until after predetermined delay period (e.g., 3 days or the like), which is after the specified date of the financial transaction.

The instructions are further configured to link 360 the resource depository 410 to an existing resource depository 420, such that, upon expiration of the time period after the specified date 322, any remaining first resources 422 in the resource depository 410 are automatically transferred to the existing resource depository 420. For example, in those embodiments of the invention in which the pending resource event fails to occur (i.e., all of the first resources 412 in the resource depository 410 are automatically transferred to the existing resource depository 422). In specific embodiments of the system 100, in which the pending resource event 320 is a financial transaction and the second resource event 326 is a security investment divestiture, the stock or real estate divestiture account may be linked to a user's checking account or savings account, such that funds remaining in the stock or real estate divestiture account after the availability delay period or some other prescribed data are automatically transferred to the user's checking or savings account.

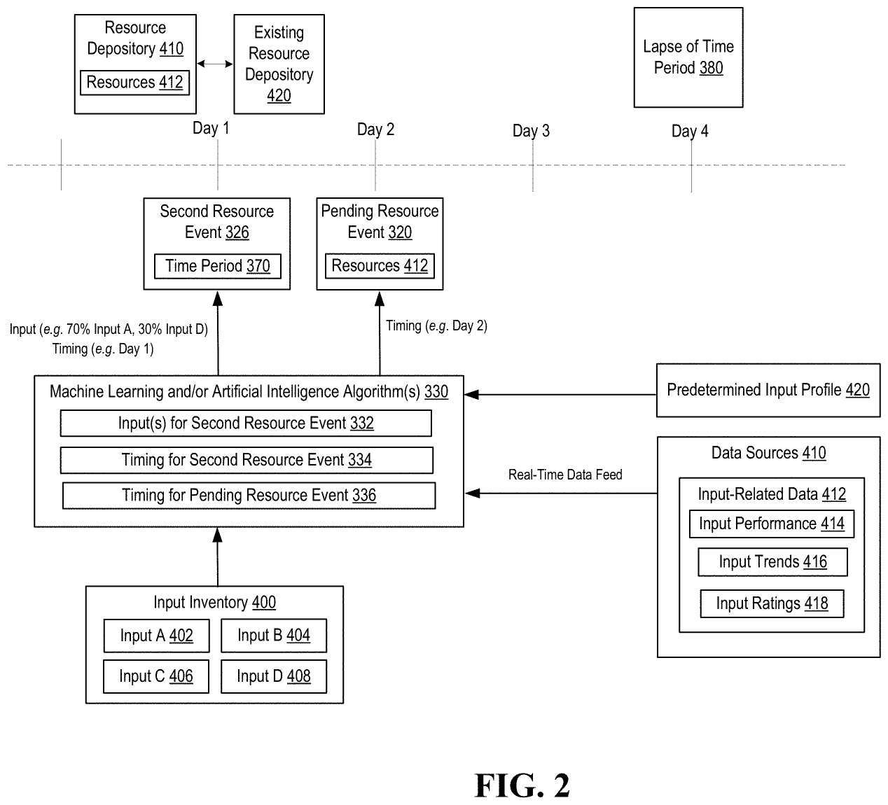

Referring to FIG. 2 a combination time line and block diagram of a system 100 for providing real-time resource distribution to a resource event having conventional delayed resource accessibility, in accordance with embodiments of the present invention. The system 100 of FIG. 2 highlights those embodiments of the invention, in which, as discussed above, ML and/or AI algorithms/models 330 are implemented to determine (i) an input for the second resource event 332, (ii) timing for the second resource event 334, and/or (iii) timing for the pending resource event 336. In such embodiments of the invention, the ML and/or AI algorithms/models are configured to receive the inputs, such as, for example, input A 402, input B 404, input C 406, and input 408 D from input inventory 400. The input to the second resource event 332 may comprise one of the inputs 402, 404, 406 and 408 or any combination of inputs 402, 404, 406 and 408. In specific embodiments of the system 100, in which the pending resource event 320 is a financial transaction and the second resource event 326 is a security investment divestiture, the input inventory 400 may be a user's current stock portfolio and/or real property holdings or the like.

In addition, the ML and/or AI algorithms/models are configured to receive input-related data 412 from one or more external or internal data sources 410. The input-related data may include input performance 414, input trend data 414, input ratings data or raw data that the ML and/or AI algorithms/models able to use to determine input performance, trends or the like. In specific embodiments of the invention, the data sources are configured to provide real-time data feeds to the ML and/or AI algorithms/models to dynamically determine the inputs and timing and insure that the determinations reflect current input performance, trends, ratings and the like. In specific embodiments of the system 100, in which the pending resource event 320 is a financial transaction and the second resource event 326 is a security investment divestiture, the input-related data may include stock performance data, stock trending data, stock ratings (e.g., buy, sell, hold) and the like). In addition, the ML and/or AI algorithms/models are configured to receive predetermined input profile data 420, such as input preference data associated with an entity performing the second resource event 326.

In specific embodiments of the system 100, in which the pending resource event 320 is a financial transaction and the second resource event 326 is a security investment divestiture, the predetermined input profile 420 may be a user's profile indication a preference as which investment security, type of investment security or real property the user desires to divest/sell. In specific embodiments of the invention, the ML and/or AI algorithms/models are configured to take into account both the input-related data 412 and the predetermined input profile 420 in determining (i) an input for the second resource event 332, (ii) timing for the second resource event 334 and/or (iii) timing for the pending resource event 336.

It should be noted that determining the input for the second resource event 332 may be directly related to or otherwise affects determining the timing for the second resource event 334 and/or (iii) timing for the pending resource event 336. Moreover, determining the timing for either the second resource event 334 or the pending resource event 336 may be directly related to or otherwise affects determining the timing for the corresponding pending resource event 336 or second resource event 334. In the illustrated example shown in FIG. 2, the ML and/or AI algorithms/models have determined that the input for the second resource event 326 is 70% of input A and 30% input D (or specified amounts of input A and input B) and the timing of the second resource event is Day 1 and the timing of the pending resource event is Day 2.

As previously discussed, the second resource event 326 has a time period 370, in this instance three days, associated with the availability of the output 328 of the resource event 326, such that, the output 328 is not available until the lapse 380 of time period 370 on day 4. In specific embodiments of the system 100, in which the pending resource event 320 is a financial transaction and the second resource event 326 is a security investment divestiture, the funds from the security investment/real property divestiture have a delay period as to the availability of the funds resulting from the divesture (e.g., three days or the like).

In the illustrated embodiment shown in FIG. 2, the second resource event 326 is conducted on Day 1 and, in response, the resource depository 410 is generated and first resources 412 are provided therein that are immediately available to conduct the pending resource event 320. In addition, the resource depository 410 is linked to an existing resource depository, such that in the event that first resources 412 remain in the resource depository 410 after the lapse 380 of the time period 370 or at some other predetermined future date, the remaining first resources 422 are automatically transferred to the existing resource depository 420. At Day 2 (as may be determined by the ML and/or AI algorithms 330) the pending resource event 320 is conducted using the first resources 412 of the resource depository 410.

In specific embodiments of the system 100, in which the pending resource event 320 is a financial transaction and the second resource event 326 is a security investment divestiture, in response to conducting the security investment/real property divesture on Day 1, a stock or real estate divestiture account is created. Funds equal to the amount of the stock or real estate divestiture or an amount sufficient to fund the financial transaction are placed in the account and made immediately available for conducting the financial transaction. On Day 2, the financial transaction occurs using the funds in the stock or real estate divestiture account.

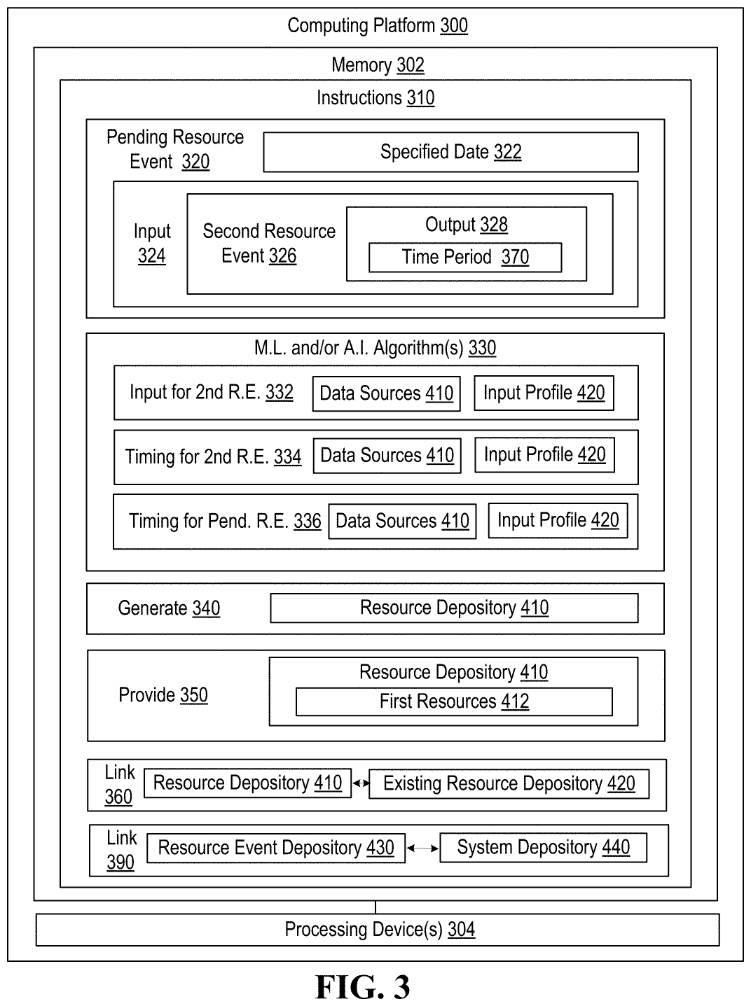

Referring to FIG. 3 a block diagram is depicted of the computing platform 300 configured for providing real-time resource distribution to a resource event having conventional delayed resource accessibility, in accordance with embodiments of the present invention. Computing platform 400, which comprises one or more computing devices (e.g., servers or the like), is configured to execute instructions 310, such as algorithms, modules, routines, applications and the like. Computing platform 300 includes memory 302, which may comprise volatile and non-volatile memory, such as read-only and/or random-access memory (RAM and ROM), EPROM, EEPROM, flash cards, or any memory common to computing platforms). Moreover, memory 302 may comprise cloud storage, such as provided by a cloud storage service and/or a cloud connection service.

Further, computing platform 300 also includes at least one processing device 304, which may be an application-specific integrated circuit (“ASIC”), or other chipset, logic circuit, or other data processing device. Processing device(s) 304 may execute one or more application programming interface (APIs) (not shown in FIG. 3) that interface with any resident programs, such as instructions 310 or the like, stored in the memory 302 of the computing platform 300 and any external programs. Processing devices(s) 304 may include various processing subsystems (not shown in FIG. 3) embodied in hardware, firmware, software, and combinations thereof, that enable the functionality of computing platform 300 and the operability of the computing platform 300 on the distributed computing network 200 (shown in FIG. 1). For example, processing subsystems allow for initiating and maintaining communications and exchanging data with other networked devices. For the disclosed aspects, processing subsystems of processing device 304 may include any subsystem used in conjunction with instructions 310 and related tools, routines, sub-routines, algorithms, sub-algorithms, sub-modules thereof.

Computing platform 300 may additionally include a communications module (not shown in FIG. 3) embodied in hardware, firmware, software, and combinations thereof, that enables electronic communications between the computing platform 300 and other network devices, such as those shown in FIG. 1. Thus, communication module may include the requisite hardware, firmware, software and/or combinations thereof for establishing and maintaining a network communication connection with one or more distributed trust.

Memory 302 of computing platform 300 stores instructions 310 that are configured to determine a pending resource event 320 occurring on a specified date 322. Determining the pending resource event 320 may be based on a user input of the pending resource event 320 requesting occurrence on a specified date 322. As previously discussed, the pending resource event 320 is configured to use, as an input 324, the output 328 of a second resource event 326. The output 328 of the second resource event 326 is not accessible until a time period 370 (e.g., one or more days) after the specified date 322. In specific embodiments of the system 100, the pending resource event 320 is a pending financial transaction, typically a financial transaction that requires a large volume of funds. In such embodiments of the system 100, the pending financial transaction may be configured to use the funds resulting from a distribution of a security investment (e.g., stocks, mutual fund, commodities, or the like), real property or the like in which the distribution is not typically available to the seller until after a delay period (e.g., three days or the like).

In specific optional embodiments of the system 100, the instructions 310 are further configured to implement one or more Machine Learning (ML) algorithms/models and/or one or more Artificial Intelligence (AI) algorithms/models 330 to determine (i) an input for the second resource event 332, (ii) timing for the second resource event 334 and/or (iii) timing for the pending resource event 336. The determinations may be made based on input-related data (e.g., performance trend, ratings or the like) received from external or internal data sources 410. In specific embodiments of the invention, the data sources 410 are configured to provide a real-time data feed to the ML and/or AI algorithms/models 330. In other embodiments of the invention, the determinations are made based on input profiles 420 that indicate a preference for which inputs to use and/or the timing for conducting resource events. In specific embodiments of the invention, both the input-related data (e.g., performance trend, ratings or the like) received from external or internal data sources 410 and the data from the input profile 420 are used to determine (i) an input for the second resource event 332, (ii) timing for the second resource event 334 and/or (iii) timing for the pending resource event 336.

In specific embodiments of the system 100, in which the pending resource event 320 is a financial transaction and the second resource event 326 is a security investment divestiture, In specific embodiments of the system 100, the input-related data may include stock performance data, stock trending data, stock ratings (e.g., buy, sell, hold) and the like) and the input profile 420 may be a user's profile indicating a preference as which investment security, type of investment security or real property the user desires to divest/sell.

The instructions 310 are further configured, in response conducting the second resource event 326 on or before the specified date 322, generate 340 a resource depository 410 within the memory 402 of storage unit 400 of storage apparatus 220 and provide 350 the resource depository 410 with first resources 412 in an volume/amount equal the output 328 of the second resource event and/or equal to or greater than the input 324 of the pending resource event 320. The first resources 412 provided to the resource depository 410 are available for immediate use an input 324 for conducting the pending resource event 320 on the specified date 322. In specific embodiments of the system 100, in which the pending resource event 320 is a financial transaction and the second resource event 326 is a security investment divestiture, in response to conducting the security investment/real property divesture on or before the specified date of the financial transaction, a stock or real estate divestiture account is created. Funds equal to the amount of the stock or real estate divestiture or an amount sufficient to fund the financial transaction are placed in the account and made immediately available for conducting the financial transaction. The funds in the stock or real estate divestiture account are provided by a financial institution or another entity that has control over the funds coming from stock or real estate divestiture and act as a virtual short-term loan, since the actual funds from the stock or real estate divestiture are not available to the seller until after predetermined delay period (e.g., 3 days or the like), which is after the specified date of the financial transaction.

The instructions are further configured to link 360 the resource depository 410 to an existing resource depository 420, such that, upon expiration of the time period after the specified date 322, any remaining first resources 422 in the resource depository 410 are automatically transferred to the existing resource depository 420. For example, in those embodiments of the invention in which the pending resource event fails to occur (i.e., all of the first resources 412 in the resource depository 410 are automatically transferred to the existing resource depository 422). In specific embodiments of the system 100, in which the pending resource event 320 is a financial transaction and the second resource event 326 is a security investment divestiture, the stock or real estate divestiture account may be linked to a user's checking account or savings account, such that funds remaining in the stock or real estate divestiture account after the availability delay period or some other prescribed data are automatically transferred to the user's checking or savings account. In such embodiments of the invention, the instructions may be further configured to link 390 a resource event depository 430 to a system repository 440, such that upon expiration of the time period after the specified date 322, resources outputted by the second resource event 326 are automatically transferred to the system repository 440. In specific embodiments of the system 100, in which the pending resource event 320 is a financial transaction and the second resource event 326 is a security investment divestiture, the stock or real estate account may be linked to a system account, such that funds resulting from the stock or real estate divestiture account are automatically transferred to the financial institution (i.e., system account) upon expiration/lapse of the time period 370.

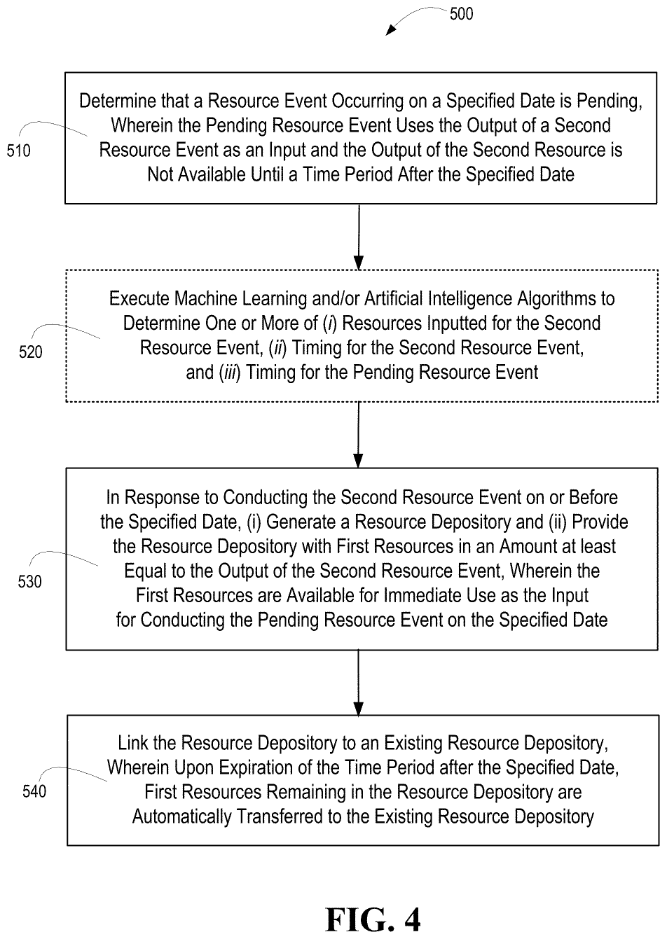

Referring to FIG. 4 a flow diagram is presented of a method 500 for providing real-time resource distribution to a resource event having conventional delayed resource accessibility, in accordance with embodiments of the present invention. At Event 510, a pending resource event occurring on a specified date is identified. The pending resource event uses, as the input, an output of a second resource event, which is not available until a time period after the specified date. In specific embodiments of the method, the pending resource event is a pending financial transaction, typically a financial transaction that requires a large volume of funds. In such embodiments of the method 500, the pending financial transaction may be configured to use the funds resulting from a distribution of a security investment (e.g., stocks, mutual fund, commodities, or the like), real property or the like in which the distribution is not typically available to the seller until after a delay period (e.g., three days or the like).

At optional Event 520, ML and/or AI algorithms/models are executed/implemented to determine one or more of (i) an input for the second resource event, (ii) timing for the second resource event and/or (iii) timing for the pending resource event. In specific embodiments of the method 500, in which the pending resource event is a financial transaction and the second resource event is a security investment/real property divestiture, the ML and/or AI algorithms/models are executed/implemented to determine which security investments or real properties to divest (e.g., which stock or combination of stocks to divest and/or which real property or properties to divest), the timing (e.g., date and, in some embodiments hour/minute) for the divesture of the security investment and/or real property and/or the timing (e.g., specific date) for the occurrence of the pending financial transaction.

At Event 530, in response to conducting the second resource event on or before the specified date, a resource depository is generated and first resource are provided to the resource depository in an amount equal to the output of the second resource event. The first resources in the resource depository are available to immediate use as the input for conducting the pending resource event on the specified date. In specific embodiments of the method 500, in which the pending resource event is a financial transaction and the second resource event is a security investment divestiture, in response to conducting the security investment/real property divesture on or before the specified date of the financial transaction, a stock or real estate divestiture account is created and funds equal to the amount of the stock or real estate divestiture or an amount sufficient to fund the financial transaction are placed in the account and made immediately available for conducting the financial transaction.

At Event 540, the resource depository is linked to an existing resource depository, such that, upon expiration/lapse of the time period after the specified date, first resources remaining in the resource depository and transferred into the existing resource depository and, in some embodiments of the invention, the resource depository is deleted. In specific embodiments of the method 500, in which the pending resource event is a financial transaction and the second resource event is a security investment/real estate divestiture, the stock or real estate divestiture account may be linked to a user's checking account or savings account, such that funds remaining in the stock or real estate divestiture account after the availability delay period or some other prescribed data are automatically transferred to the user's checking or savings account.

Thus, present embodiments of the invention provides for real-time resource distribution/availability for a resource event that typically would otherwise incur a standard delay period in resource availability. The invention generates a resource depository and provides the resource depository with resources in an amount at least equal to the output of the resource event incurring the delay period. The resources in the resource depository are immediately available as an input another resource event. In addition, the present invention provides for implementing machine learning and/or artificial intelligence to determine which resources to use as the input for the resource event that incurs a delay period and/or the timing for conducting the resource event that incurs the delay period and/or the pending resource event. While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for providing real-time resource distribution to a resource event having conventional delayed resource accessibility, the system comprising:
a distributed communication network;
a computing platform disposed in the distributed communication network and including a memory and at least one processor in communication with the memory, wherein the memory stores instructions that are executable by the processor and configured to:
determine a pending resource event on a specified date, wherein the pending resource event uses an output of a second resource event as an input, wherein the output of the second resource event is not accessible until a time period after the specified date;
in response to conducting the second resource event on or before the specified date,
generate a resource depository;
provide the resource depository with first resources in an amount equal to the output of the second resource event, wherein the first resources in the resource depository are available for immediate use as the input for conducting the pending resource event on the specified date; and
link the resource depository to an existing second resource depository, wherein upon expiration of the time period after the specified date, first resources remaining in the resource depository are automatically transferred to the existing second resource depository.

2. The system of claim 1, wherein the instructions are further configured to:
implement at least one of (i) one or more machine-learning models, or (ii) one or more artificial intelligence models to determine one or more inputs for the second resource event.

3. The system of claim 2, wherein the instructions are further configured to:
receive real-time data feeds indicating at least one of (i) input performance, (ii) input trends, and (iii) input ratings; and
determine the one or more inputs for the second resource event based at least on one or more of (i) the input performance, (ii) the input trends, and (iii) the input ratings.

4. The system of claim 1, wherein the instructions are further configured to:
determine one or more inputs one or more for the second resource event based at least on a predetermined input profile.

5. The system of claim 1, wherein the instructions are further configured to:
implement at least one of (i) one or more machine-learning models, or (ii) one or more artificial intelligence models to determine a timing for conducting the second resource event.

6. The system of claim 1, wherein the instructions are further configured to:
receive real-time data feeds indicating at least one of (i) input performance, (ii) input trends, and (iii) input ratings; and
determine the timing for the second resource event based at least on one or more of (i) the input performance, (ii) the input trends, and (iii) the input ratings.

7. The system of claim 1, wherein the instructions are further configured to:
implement at least one of (i) one or more machine-learning models, or (ii) one or more artificial intelligence models to determine the specified date for conducting the pending resource event.

8. The system of claim 1, wherein the instructions are further configured to:
in response to expiration of the time period after the specified date or using all of the first resources in the resource depository, delete the resource depository.

9. A computer-implemented method for providing real-time resource distribution to a resource event having standard delayed resource accessibility, the method executed by one or more computing processing device and comprising:
determining a pending resource event occurring on a specified date, wherein the pending resource event uses an output of a second resource event as an input, wherein the output of the second resource event is not accessible until a time period after the specified date;
in response to conducting the second resource event on or before the specified date,
generating a resource depository;
providing the resource depository with first resources in an amount equal to the output of the second resource event, wherein the first resources in the resource depository are available for immediate use as the input for conducting the pending resource event on the specified date; and
linking the resource depository to an existing second resource depository, wherein upon expiration of the time period after the specified date, first resources remaining in the resource depository are automatically transferred to the existing second resource depository.

10. The method of claim 9, further comprising:
executing at least one of (i) one or more machine-learning models, or (ii) one or more artificial intelligence models to determine one or more inputs for the second resource event.

11. The method of claim 9, further comprising:
executing at least one of (i) one or more machine-learning models, or (ii) one or more artificial intelligence models to determine a timing for conducting the second resource event.

12. The method of claim 9, further comprising:
executing at least one of (i) one or more machine-learning models, or (ii) one or more artificial intelligence models to determine the specified date for conducting the pending resource event.

13. The method of claim 10, further comprising:
in response to expiration of the time period after the specified date or using all of the first resources in the resource depository, deleting the resource depository.

14. A computer program product comprising:
a non-transitory computer-readable medium comprising:
a first set of codes for causing a computer to determine a pending resource event on a specified date, wherein the pending resource event uses an output of a second resource event as an input, wherein the output of the second resource event is not accessible until a time period after the specified date; and
a second set of codes for causing a computer to, in response to conducting the second resource event on or before the specified date, (i) generate a resource depository, (ii) provide the resource depository with first resources in an amount equal to the output of the second resource event, wherein the first resources in the resource depository are available for immediate use as the input for conducting the pending resource event on the specified date, and (iii) link the resource depository to an existing second resource depository, wherein upon expiration of the time period after the specified date, first resources remaining in the resource depository are automatically transferred to the existing second resource depository.

15. The computer program product of claim 14, further comprising a third set of codes for causing a computer to execute at least one of (i) one or more machine-learning models, or (ii) one or more artificial intelligence models to determine one or more inputs for the second resource event.

16. The computer program product of claim 14, further comprising a third set of codes for causing a computer to execute at least one of (i) one or more machine-learning models, or (ii) one or more artificial intelligence models to determine a timing for conducting the second resource event.

17. The computer program product of claim 14, further comprising a third set of codes for causing a computer to execute at least one of (i) one or more machine-learning models, or (ii) one or more artificial intelligence models to determine the specified date for conducting the pending resource event.

18. The computer program product of claim 14, further comprising a third set of codes for causing a computer to, in response to expiration of the time period after the specified date or using all of the first resources in the resource depository, deleting the resource depository.

19. The system of claim 1, wherein the instructions are further configured to link a second resource depository holding the output of the second resource event to a system depository, wherein upon lapse of the delay period the output of the second resource event is automatically transferred to the system depository.

20. The computer program product of claim 14, further comprising a third set of codes for causing a computer to link a second resource depository holding the output of the second resource event to a system depository, wherein upon lapse of the delay period the output of the second resource event is automatically transferred to the system depository.
